(19) United States
(12) Patent Application Publication
(10) Pub. No.: US 2002/0129378 A1
(43) Pub. Date: Sep. 12, 2002

(54) Method and apparatus for controlling traffic loading on a cable modem termination system

(76) Inventors: Thomas J. Cloonan, Lisle, IL (US); Daniel W. Hickey, Oswego, IL (US)

Correspondence Address: VEDDER PRICE KAUFMAN & KAMMHOLZ, 222 N LASALLE STREET, CHICAGO, IL, 60601, US

(21) Appl. No.: 09/802,250

(22) Filed: Mar. 8, 2001

(51) Int. Cl. H04N 7/173

(52) U.S. Cl. 725/111; 725/109; 725/95; 725/117; 725/118

(57) ABSTRACT

A method and apparatus for controlling traffic loading on a cable modem termination system helps provide viable quality of service (QoS) capability on a cable data system. Available data bandwidth on a particular channel is first determined, followed by a comparison of the amount of bandwidth requested by, or required by a new subscriber. If the bandwidth available on a particular channel is adequate, service can be provided on the channel, otherwise the new subscriber is assigned to a new channel to avoid data overload.

### FIELD OF THE INVENTION

The present invention relates to a method and apparatus for controlling traffic loading on a cable modem termination system using connection admission control.

### BACKGROUND OF THE INVENTION

In order to provide more products to their subscriber base, cable television companies are offering access to the Internet through their cable modem (CM) boxes. The benefits in using the cable companies instead of a dial-up Internet Service Provider is multiple services under one bill, always-on access, and, in some cases, higher speed access.

In order to provide their customers with Internet access, the cable companies use some of the 50-800 MHZ spectrum typically set aside for their television channels to provide the bandwidth required for the data transfers. A typical cable system has the bandwidth to provide 100 television channels to its subscribers. Each NTSC television signal requires 6 MHZ of bandwidth.

In order for a cable subscriber to access the Internet through their cable television provider, the subscriber must have a CM. The CM is similar to the Cable Modem Termination System (CMTS) equipment required at the cable company's headquarters, except for the greater size required at the headquarters. This is to accommodate a greater number of signals than is required by the home modem.

The home CM box and the CMTS use well-known Ethernet frames to communicate between them. The cable data system, however, uses a different modulation scheme, Quadrature Amplitude Modulation (QAM), than is normally used in an Ethernet scheme.

Using the QAM modulation, the downstream (from the cable company equipment to the home CM) data rate is in the range of 30-40 Mbps for each 6 MHZ channel. This can accommodate between 500 and 2000 subscribers, The more subscribers that the cable company tries to fit in that spectrum, the lower quality signal for each subscriber results.

The upstream data flow is different and more complex. In the past, cable companies did not have to worry about providing bandwidth for the customer to communicate in the upstream direction. Pay-for-view movies and sports events, however, required this ability. The cable companies. Therefore, set aside the 5-42 MHZ spectrum to provide the necessary upstream access to the Internet from the home CM.

The world is now on the verge of a revolution that promises to change the way the Internet works and it is guaranteed to change the way the entire world communicates, works and plays. The revolution is the introduction of quality of service (QoS) to the Internet. This QoS revolution is already beginning, because most computer networking products (switches and routers) have already added some type of QoS to their feature sets. Unfortunately, there are many different forms of QoS from which to choose and they are not all compatible with one another. Different standards committees (Diffserv, RSVP, NTLS, etc.) are still deciding which of many different QoS proposals will actually be used in the Internet, and hybrid solutions will likely be developed in the very near future that will enable the QoS revolution.

The change is important, because it will eliminate the current Internet routing model that provides the same “best effort” service to all users, all packets, and all traffic flows. When QoS is enabled in a ubiquitous, end-to-end fashion across the Internet, differentiated services will be permitted, and all packets will be treated differently. High priority packets will be routed with lower latency and lower jitter, while low priority packets may experience more delay and jitter. The throughput needs of each application will determine the priority associated with its corresponding traffic flows, and it is likely that advanced application programs of the future will dynamically change the priority of traffic flows to match the very needs of the user through the entire duration of the session.

Since all packets will not be passed using the same priority level, it follows that all packets cannot be billed using the same charges in the future either. Future Internet users are likely to pay differently for different classes of service, and they may even be billed on a usage basis, e.g., per-minute, per packet, or per byte, similar to the billing schemes used for long distance telephone service today. The use of high priority traffic flow for an application will undoubtedly result in higher Internet usage costs than the use of low priority traffic flows and service level agreements (SLAs) between the Internet user and their service provider will detail the available priority and throughputs in and their associated costs. These changes in the Internet billing model represent enhanced revenue generating potential for access providers that can provide and bill for these new differentiated services, and multiple system operators (MSOs) are key members of this group.

MSOs are positioned in an ideal location within the Internet to play a major role in the QoS revolution, and they will be able to capitalize on the resulting changes. This is because the MSOs are positioned to act as the QoS gatekeeper into the future Internet. They can perform this function because they have access to each subscriber's service level contract and can appropriately mark the priority of all packets that are injected into the Internet by their subscribers. In fact, the MSOs head end equipment, the cable modem termination system CMTS is actually the first piece of trusted equipment not owned by the subscriber to which subscriber packets must pass on their way to the Internet. The CMTS is positioned at the head end office and it provides basic connectivity between the cable plant and the Internet. FIG. 1 illustrates a simplified cable data system 10 with a CMTS 30. The CMTS 30 is connected through Internet link 40 to the Internet 20. The CMTS 30 is also connected through various cable links 50 to a plurality of subscribers 60.

The MSO also provides customer subscription packages and is able to offer (and bill for) many different subscriber service levels. In addition, if the CMTS equipment permits it, the MSO will also be able to offer dynamic service level upgrades to its subscribers. Features contained within an MSOs CMTS must provide most of these revenue generating QoS capabilities. This will result in even greater increases in revenues if the MSOs can maintain adequate counts on usage of different services levels consumed by its subscribers.

As set forth above, this CMTS provides basic connectivity between the cable plant and the local area network that interfaces to an edge router on the Internet. The CMTS is responsible for appropriately classifying, prioritizing, flow controlling, queuing, scheduling and shaping all the traffic flows between cable data subscribers and the Internet. As a result, this type of service experienced by the cable data subscribers will primarily be determined by the features in the CMTS core.

One important task of the CMTS will be congestion control. If the traffic congestion on all of the channels into and out of the CMTS is not carefully monitored and controlled, information will be lost and subscribers will become dissatisfied with the service.

### SUMMARY OF THE INVENTION

The invention provides a traffic congestion control solution for use on all channels coming into and out of a CMTS. The system first determines the amount of bandwidth available in a certain direction and then determines how much bandwidth is being requested by a subscriber. The system then determines whether or not to accept the subscribers request using a connection admission control algorithm.

According to one embodiment of the present invention, a method and system for controlling traffic loading on a cable modem termination system (CMTS) for a cable data system, is disclosed. First, the available bandwidth on a requested data channel is determined. Then, the available bandwidth on the requested data channel is compared to the bandwidth being request by a new subscriber. The system then determines whether the available bandwidth is greater than, less than or equal to the bandwidth to be allocated by the CMTS to the new subscriber, and grants or denies cable data service to the new subscriber based upon the determination of whether the available bandwidth is greater than, less than or equal to the bandwidth to be allocated to the new subscriber.

### BRIEF DESCRIPTION OF THE DRAWINGS

The teachings of the invention can be readily understood by considering the following detailed description in conjunction with the accompanying drawings, in which:

FIG. 1 illustrates an exemplary cable data system;

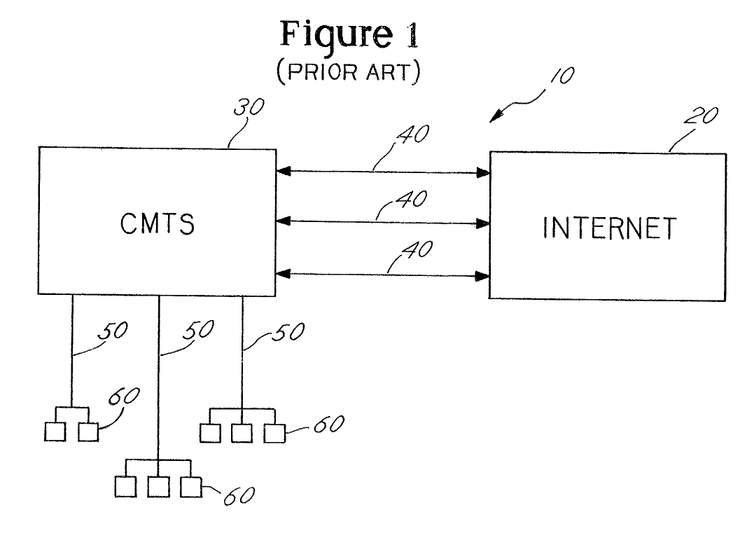

FIG. 2 illustrates a CMTS according to one embodiment of the invention; and

FIG. 3 illustrates a cable data system according to one embodiment of the invention.

### DETAILED DESCRIPTION

According to one embodiment of the invention, a connection admission control system is used in a CMTS to provide congestion control. Connection admission control (CAC) systems are well known in the field of ATM networks. See e.g., U.S. Pat. No. 6,046,981, issued Apr. 4, 2000 to Ramamurthy, et al., for a “Multi-Class Connection Admission Control Method for Asynchronous Transfer Mode (ATM) Switches.” See also U.S. Pat. No. 5,862,126 issued Jan. 19, 1999 to Shah et al., for “Connection Admission Control for ATM Networks” and see U.S. Pat. No. 5,894,471 to Miyagi, et al., for a “ATM Network System and Connection Admission Control Method.”

CAC system use algorithms, which use traffic descriptors (e.g., peak rate, mean rate also referred to as average rate or sustainable bit rate and maximum burst size) along with the desired QoS parameters (e.g., cell loss, cell delay and cell delay variation) to access the amount of available bandwidth required by the connection. The decision to accept or reject a connection is then based on the amount of available bandwidth on the outgoing link, in addition to other parameters, which the network administrator may deem necessary to consider.

The CAC principles from ATM networks can be applied to traffic control within a cable data system and its CMTS. A description of an illustrative CMTS will now be given followed by a discussion of how to use CAC in a CMTS.

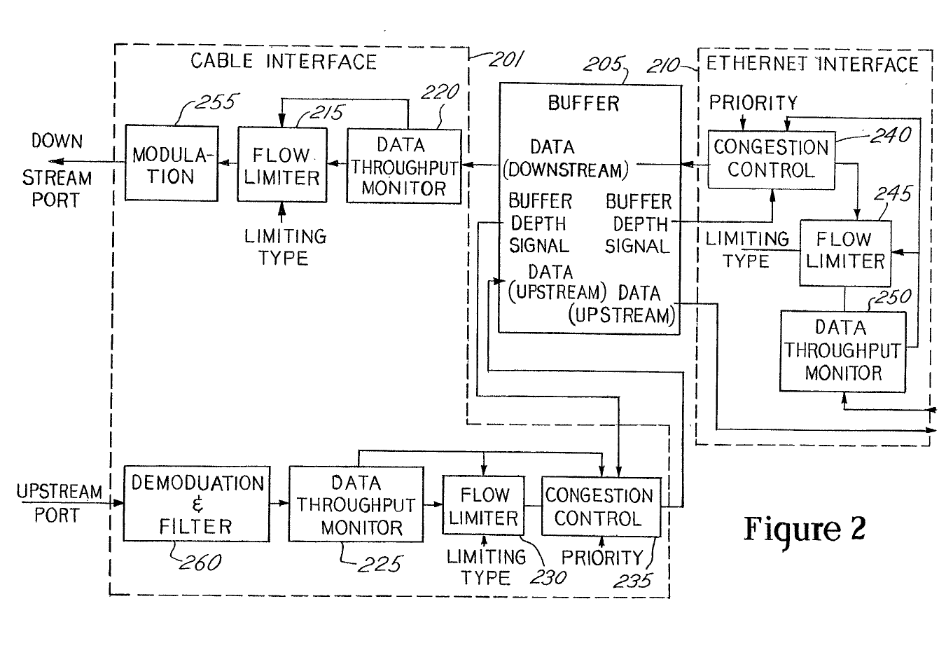

FIG. 2 illustrates the preferred embodiment cable modem termination system (CMTS) apparatus of the present invention. The CMTS apparatus of FIG. 2 is comprised of a cable interface (201) that is coupled to a buffer circuit (205). The buffer circuit (205) is coupled to an Ethernet interface (210). In the preferred embodiment, each of the individual circuits (201, 205, and 210) reside physically on separate circuit boards. In alternate embodiments, any circuits having substantially the same function can reside on one circuit board or even one integrated circuit. In other words, the present invention is not limited to three separate circuit boards.

The cable interface (201) is responsible for interfacing the CMTS to the home cable modem apparatus. The cable interface (201) also provides the functions of modulation and demodulation.

The cable interface circuit is comprised of a downstream packet flow path and an upstream packet flow path. The downstream packet flow path is comprised of a data throughput monitor (220) that is coupled to a flow limiter (215). The data throughput monitor (220) has an input that is coupled to the buffer circuit (205) from which the data packets flow and a feedback from the upstream path. The feedback from the upstream path is to allow a first CM to talk with other CMs. The data throughput monitor (220) has the task of determining the rate of data packet flow.

In the preferred embodiment of the CMTS, the downstream data packet flow rate is typically either 30 or 40 Mbps for each 6 MHZ channel, using QAM techniques. Alternate embodiments use other flow rates. The cable company decides which data packet flow rate depending on the outcome desired by the company. The lower data rate is less susceptible to noise while the higher data rate can include more data per unit of time for the customers.

The data packet flow rate signal is fed into the flow limiter (215). This signal controls the flow limiter function. If the flow is greater than a predetermined level, Tₘₐₓ, the data packet flow can be limited. The flow limiter (215) reduces the data rate by dropping packets until the flow is reduced to below Tₘₐₓ.

Another input to the flow limiter (215) is the Alimiting type≅input. This control input is set by the cable company depending on how strict they wish a customer to adhere to the rules. If the “limiting type” input is set to “soft-limiting,” the flow limiter (215) allows the data rate to go above the set data rate by a predetermined amount without dropping any packets.

Some cable companies may strictly limit a customer to Tₘₐₓ. In this case, the “limiting type” control input is set to “hard-limiting.” If the data rate goes over the set hard limit, the flow limiter (215) drops any packets that force the customer to exceed Tₘₐₓ. The output of the flow limiter (215) is coupled to the cable that runs to the customers=cable modems.

The output of the flow limiter (215) is input to the modulator (255). This block (255) performs the QAM needed to transmit the data to the CMs.

The upstream data path is comprised of a demodulator and filter (260) that converts the QAM signal into data bits in order to be processed by the other blocks in the upstream path. The demodulated data bits are input to a data throughput monitor (225) that is coupled to the upstream port from the customer's CM. This data throughput monitor (225) has the same functionality as the downstream monitor (220) of monitoring the data rate but in the upstream direction to the Internet.

In the preferred embodiment, the upstream data rate can be in the range of 320 kb to 10.24 Mbps. Alternate embodiment use other rates.

The upstream data throughput monitor (225) is coupled to a flow limiter (230). This flow limiter has similar functionality to the flow limiter (215) in the downstream path. The upstream path flow limiter (230) has the data rate input from the data throughput monitor (225) as well as the “limiting type” control input that, in the preferred embodiment, is set to either “hard-limiting” or “soft-limiting” depending on the cable company rules. As in the downstream flow limiter (215), the upstream flow limiter, depending on the “limiting type” input, drops all packets that force the customer to exceed Tₘₐₓ.

The upstream path further comprises a congestion control block (235) that is coupled to the upstream data path out of the flow limiter (230). According to one embodiment of the invention, the congestion control block (235) can comprise, among other features, a CAC system, but the invention is not limited thereto. The data packets from the upstream data path flow through the congestion control block (235) to the buffer circuit (205). The function of the congestion control block (235) is to drop packets when the buffer depth is reaching a maximum point. By dropping the packets before they reach the buffer, the buffer will not overflow.

In order to accomplish the task of congestion control, the congestion control block (235) has control inputs that are used to determine when to drop packets and which packets to drop. In the preferred embodiment, these control inputs include the data rate signal from the upstream data throughput monitor (225), a buffer depth signal from the buffer (205), and a priority signal.

The data rate signal from the upstream data throughput monitor (225), as described above, “quantizes” the data rate and feeds that value to the congestion control block (235). The buffer circuit depth signal from the buffer circuit (205) instructs the congestion control block (235) as to the depth of the buffer. In other words, if, for example, the buffer (205) is 75% full, the buffer depth signal instructs the congestion control block (235) of this.

The priority signal that is input to the congestion control block (235) informs the congestion control of the priority of each packet. This is important in determining which packets to drop.

A group of packets is assigned a priority based on the customer's level of service plan. If the customer has signed up for the basic service plan and paid the smallest fee for the most basic service, his packets are assigned a low priority. This priority is embedded in a packet identification that is assigned to the group of packets and is decoded when the group of packets enters the cable interface.

If the customer has signed up for the premium service plan with the cable company, his packets are assigned the highest priority. If the customer has signed up for any service plans that are in between the premium and the basic plans, this priority is also assigned to each packet. As described before, the priority is added to the packet identification for a particular group of packets.

A customer may also decide to dynamically change his service level for a given session. In this case, different packet groups from that particular customer will have different priorities assigned to different packet identifications.

As described subsequently in other figures, the congestion control block (235) of FIG. 2 uses the priority assigned to a group of packets to determine how to process that particular group of packets. The output of the congestion control block is input to the buffer circuit's upstream data flow input.

The buffer circuit (205) stores the packets until the Ethernet circuit (210) has time to process that packet. The packets are fed from the buffer circuit (205) to the Ethernet circuit (210) as more processing time is freed up.

The downstream path of the Ethernet circuit (210) is comprised of a data throughput monitor (250) that is coupled to the connection to the Internet. This monitor (250) provides substantially the same function as the previously described data throughput monitors on both the upstream and downstream paths.

The data packets from the Internet flow from the data throughput monitor (250) to the Ethernet circuit flow limiter (245). This flow limiter (245) has substantially the same functionality as the above described flow limiters. This flow limiter also has the same inputs as described previously: the quantized data rate and the “limiting type” control input.

The data packets flow from the flow limiter (245) to the congestion control block (240). As in the upstream congestion control block (235), the Ethernet downstream congestion control block (240) has the three control inputs to determine which packets to drop: the quantized data rate, the buffer depth signal, and the packet priority signal. The congestion control block then drops a particular packet based on these control signals.

The downstream data flows from the congestion control block to the buffer circuit (205). The buffer circuit (205) stores the packets until the cable interface circuit has the processing time to work on additional packets.

The buffer circuit (205) is comprised of 128 MB of RAM, in the preferred embodiment. Alternate embodiments use other values of RAM or even other types of memory instead of RAM. The alternate types of memory include hard drives or other types of temporary memory.

The functions illustrated in FIG. 2 may be implemented in various ways, using various well known structures that include microprocessors, digital signal processors or combinations thereof, all of which are well known to those skilled in the art. Hardwired combinational logic or application specific integrated circuits might also be used. The functions of these elements can certainly be performed in software by a processor or multiple processors performing each function. Each function can also be implemented in discrete logic hardware, a digital signal processor, or some other form of programmable logic.

According to one embodiment of the invention, CAC is run on at least one and preferably every link or connection to and from the CMTS, however, the invention is not limited thereto. To use CAC in a CMTS, the CMTS needs to determine various minimum and maximum bandwidth requirements (Tmin, Tmax) for each subscriber. When a cable modem (CM) is activated (powered-up) a service flow is established between the CM and the CMTS. The service flow comprises, among other information, the Tmin, Tmax values for that particular CM. The Tmin, Tmax values may depend on a variety of factors, such as, for example, the capabilities of the CM, the level of service to which the subscriber has subscribed, etc. The Tmin value is the minimum amount of bandwidth that will be available to the subscriber when access is granted, while the Tmax value is the maximum amount of bandwidth that the subscriber can expect to receive when access is granted.

When the CMTS receives a data request from a new subscriber, CAC first determines the amount of bandwidth available on the link or connection the subscriber is requesting. CAC then determines how much bandwidth is being requested. CAC then determines whether or not the request can be accepted. In addition to the present capacity, CAC also takes into consideration the Tmin, Tmax values of the subscriber. CAC has a variety of options when a new request is received. For example, CAC can accept the request, deny the request, accept the request but flag the condition on the link or connection as being oversubscribed, and/or switch the subscriber to a different link or connection if available.

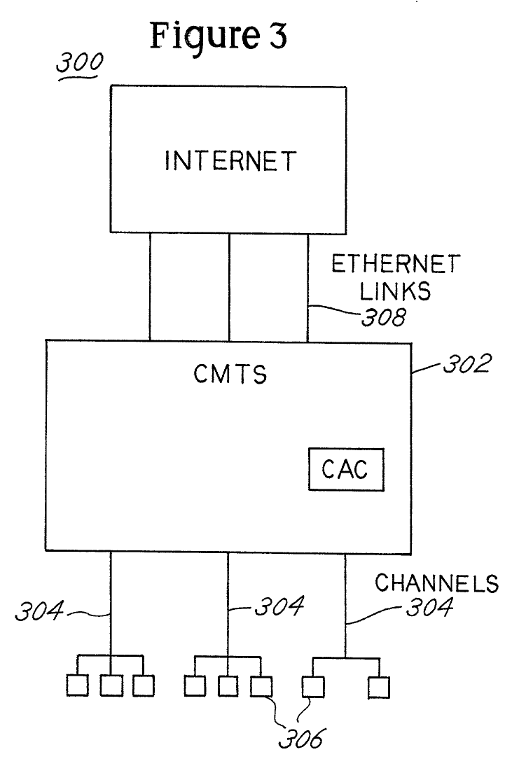

Several examples of using CAC on the links of a CMTS will now be described with reference to FIG. 3 which illustrates a system 300 which includes a CMTS 302 according to the invention. The CMTS 302 has a plurality of channels (links) 304 which connect the CMTS 302 to a plurality of subscriber CM=s 306. The CMTS 302 also has a plurality of Ethernet links 308 which connect the CMTS to the Internet. The CAC system can be used to monitor traffic congestion on all of the channels 304 and 308 in both the upstream and downstream directions.

In this example, the downstream bandwidth for each channel 304 is 30 Mb/s and the downstream bandwidth for each Ethernet link 308 is 100 Mb/s. It will be understood that these values have been picked for illustration purposes and the invention is not limited to these values. In this example, 30 subscribers are sequentially requesting service on channel 1, wherein each subscriber is requesting 1 Mb/s of bandwidth. CAC receives each request and checks the capacity of the channel and grants each request so long as the requests are below the Tmax values for each subscriber. When the 31st subscriber request 1 Mb/s of bandwidth on channel 1, CAC will determine that the channel is already operating at its maximum capacity of 30 Mb/s. The CMTS now has several options. First, CAC can deny the request of the 31 st subscriber. However, CAC may also decide to accept the request and flag the channel as being over subscribed. In this scenario, some data packets from some or all of the subscribers may be lost in order to grant subscriber 31's request. The amount of packet loss that is acceptable to the system is determined by the system administrator and is a parameter used by CAC when deciding whether to grant access to a subscriber. The packets can be lost randomly or the CMTS can pick packets depending on the level of service each subscriber has selected, wherein subscribers with higher priority service lose less packets. Alternatively, CAC can switch subscriber 31 from channel 1 to another channel which has more available bandwidth.

CAC works in the same manner on the Ethernet links 308. If link 1 is presently operating at 100 Mb/s and a new subscriber requests bandwidth on link 1, CAC can either accept and oversubscribe the link, deny the request, or move the new subscriber to a less congested link.

While exemplary systems and method embodying the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments.

We claim:

1. A method of controlling traffic loading on a cable modem termination system (CMTS) for a cable data system, comprising the steps of:
determining the available bandwidth on a requested cable data system channel;
comparing the available bandwidth on the requested cable data system channel to bandwidth being request by a new subscriber;
determining whether the available bandwidth is greater than, less than or equal to the bandwidth to be allocated by the CMTS to the new subscriber; and
granting or denying cable data service to the new subscriber based upon the determination of whether the available bandwidth is greater than, less than or equal to the bandwidth to be allocated to the new subscriber.

2. The method according to claim 1, further comprising the step of:
transferring the new subscriber to a different cable data system channel with more available capacity when the available bandwidth on the requested cable data system channel is less than the bandwidth to be allocated to the new subscriber.

3. The method according to claim 1, wherein said cable data system channels are upstream channels to the CMTS.

4. The method according to claim 1, wherein said cable data system channels are downstream cable data system channels from the CMTS.

5. The method according to claim 1, further comprising the steps of:
granting cable data system service to said new subscriber on said requested cable data system channel even though the available bandwidth on the requested cable data system channel is less than the bandwidth being allocated to the new subscriber; and
flagging said requested cable data system channel as being over subscribed.

6. The method according to claim 5, wherein data packets for at least some subscribers are lost when said cable data system channel is over subscribed.

7. The method according to claim 6, wherein data packets are randomly lost.

8. The method according to claim 6, wherein data packets are selected to be lost based on each subscribers level of service, wherein higher levels of service lose less packets.

9. A system controlling traffic loading on a cable modem termination system (CMTS) for a cable data system, comprising:
means for determining the available bandwidth on a requested cable data system channel;
means for comparing the available bandwidth on the requested cable data system channel to bandwidth being request by a new subscriber;
means for determining whether the available bandwidth is greater than, less than or equal to the bandwidth to be allocated by the CMTS to the new subscriber; and
means for granting or denying cable data system service to the new subscriber based upon the determination of whether the available bandwidth is greater than, less than or equal to the bandwidth to be allocated to the new subscriber.

10. The system according to claim 9, further comprising:
means for transferring the new subscriber to a different cable data system channel with more available capacity when the available bandwidth on the requested cable data system channel is less than the bandwidth to be allocated to the new subscriber.

11. The system according to claim 9, wherein said cable data system channels are upstream channels to the CMTS.

12. The system according to claim 9, wherein said cable data system channels are downstream channels from the CMTS.

13. The system according to claim 9, further comprising:
means for granting cable data system service to said new subscriber on said requested data channel even though the available bandwidth on the requested data channel is less than the bandwidth being allocated to the new subscriber; and
means for flagging said requested data channel as being over subscribed.

14. The system according to claim 13, wherein data packets for at least some subscribers are lost when said data channel is over subscribed.

15. The system according to claim 14, wherein data packets are randomly lost.

16. The system according to claim 14, wherein data packets are selected to be lost based on each subscribers level of service, wherein higher levels of service lose less packets.
